(19) United States
(12) Patent Application Publication
(10) Pub. No.: US 2001/0055989 A1
(43) Pub. Date: Dec. 27, 2001

(54) Apparatus for playing a game

(76) Inventor: James David Thomas, Loughborough (GB)

Correspondence Address: Michael E. Sellers, Esq, Luedeka, Neely & Graham, P.C., P.O. Box 1871, Knoxville, TN, 37901, US

(21) Appl. No.: 09/775,928

(22) Filed: Feb. 2, 2001

Related U.S. Application Data
(63) Continuation of application No. PCT/GB99/02552, filed on Aug. 3, 1999.

(30) Foreign Application Priority Data
Aug. 3, 1998 (GB) 9816883.4

(51) Int. Cl. A63F 9/24; G06F 17/00

(52) U.S. Cl. 463/16

(57) ABSTRACT

The present invention relates to (with reference to FIG. 1), apparatus (10) for playing a game. The apparatus (10) has a payment acceptor (30,31) for receiving payment of a stake from a player of the game. The apparatus (10) has a plurality of randomisers (60, 70) each of which can generate a random combination of indicia from a set of available indicia. The apparatus (10) has a plurality of selectors (52, 53) operable by a player for selecting one or more of the plurality of randomisers (60, 70) to be played in a turn of play. The apparatus (10) has activating means (54) for activating the randomisers (60, 70) and comparator means for determining a winning combination of indicia. The apparatus (10) has payment means (90) for awarding a winning payment to a winning player of the game.

The activating means (54) in every turn of play activates all of the randomisers (60, 70) and in every turn of play each randomiser generates a random combination of indicia. Each of the randomisers (60, 70) comprises a set of rotatable mechanical reels. The randomisers (60, 70) operate independently of each other such that the chances of one randomiser (60, 70) generating a particular set of indicia are completely unaffected by the indicia generated by any other randomiser. Each of the plurality of selectors (52, 53) is associated with only one of the plurality of randomisers (60, 70) and is used by a player to select only the associated randomiser (60, 70) for play in a turn of play.

The comparator means determines a winning combination of indicia by both separately for each set of reels (60, 70) checking whether the generated indicia comprises a winning combination and by checking which set or sets of reels (60, 70) have been selected for play. The comparator means determines a win only when a selected set of reels (60, 70) displays a winning combination of indicia.

The present invention relates to apparatus for playing a game and in particular to apparatus for playing an automated game of chance requiring a stake to be gambled.

Automated games of chance where money is staked, commonly referred to as gaming machines or fruit machines, are well know in the art and are widely available in a number of different game formats and themes. The gaming machines are provided for the purposes of entertainment, recreation and sport, and are sited at venues such as leisure centres, public houses, amusement arcades, clubs, bingo halls and casinos. In particular, gaming machines are sited in considerable numbers at dedicated gaming centres such as bingo halls and casinos.

Typically, a player has only had the opportunity to vary the challenge faced or stakes involved when playing a gaming machine by choosing between the range of particular game formats or themes available on different machines at a site. This choice is often limited where there are few machines or many machines of similar game formats or themes. A restricting feature of most gaming machines of the prior art is that each machine is provided with only one randomiser means, the randomiser means being the device used to generate a random combination of indicia in each turn of play to determine whether or not a player of a game has won. Accordingly, because a player has only one randomiser available to play in each turn of play, a player is limited to a maximum of one win in that turn of play. It has been noticed that certain players play a number of gaming machines sited in close proximity and play the gaming machines simultaneously.

In GB-A-2239547 apparatus for playing a game is described in which two independently playable fruit machine games are provided in a single cabinet. it is preferred that the games are provided with a common coin validator. Game selection means can be provided to select between the games. A common credit register can be provided along with a common controller for implementing the two machine games. The games can be started and played simultaneously. Thus, a player can play two games together provided in one cabinet. However, it is not disclosed that the apparatus of GBA-2239547is arranged such that the reels of both games spin in every turn of play regardless of which game or games is/are selected. The apparatus does not describe use of “nudges” and “holds”.

In EP-A-0070679 apparatus for playing a game is described in which mechanical reels are not used and instead separate images are generated optically or electronically in three separate rows of three images. The symbols in all rows change in every turn of play. Wins can be determined by vertical and diagonal playlines as well as by horizontal play-lines. The specification teaches that mechanical reels cannot be used and the described apparatus does not permit use of a “nudge” function.

The present invention provides apparatus for playing a game comprising:

a payment acceptor for receiving payment of a stake from a player of the game;

a plurality of randomisers each of which can generates a random combination of indicia from a set of available indicia;

a plurality of selectors operable by a player for selecting one or more of the plurality of randomisers to be played in a turn of play;

activating means for activating the randomisers;

comparator means for determining a winning combination of indicia; and

payment means for awarding a winning payment to a winning player of the game; wherein:

the activating means in every turn of play activates all of the randomisers and in every turn of play each randomiser generates a random combination of indicia;

each of the randomisers comprises a set of rotatable mechanical reels;

the randomisers operate independently of each other such that the chances of one randomiser generating a particular set of indicia are completely unaffected by the indicia generated by any other randomiser;

each of the plurality of selectors is associated with only one of the plurality of randomisers and is used by a player to select only the associated randomiser for play in a turn of play; and

the comparator means determines a winning combination of indicia by both;

separately for each set of reels checking whether the generated indicia comprises a winning combination; and

by checking which set or sets of reels have been selected for play,

the comparator means determining a win only when a selected set of reels displays a winning combination of indicia.

The present invention provides apparatus for playing a game comprising a plurality of independent randomisers which enables a player to play one or a plurality of the independent randomisers in each turn of play on just one apparatus. In the apparatus each randomiser generates indicia, irrespective of whether the randomiser is selected. To determine a win the comparison means must both (a) check whether symbols in a set of reels indicate a win and (b) check whether the set of reels have been selected for play. The apparatus in a turn of play can have a set of reels displaying a winning combination of indicia without the apparatus awarding a win because the reels are not selected.

Preferred embodiments of the present invention will now be described by way of examples only with reference to the accompanying drawings in which:

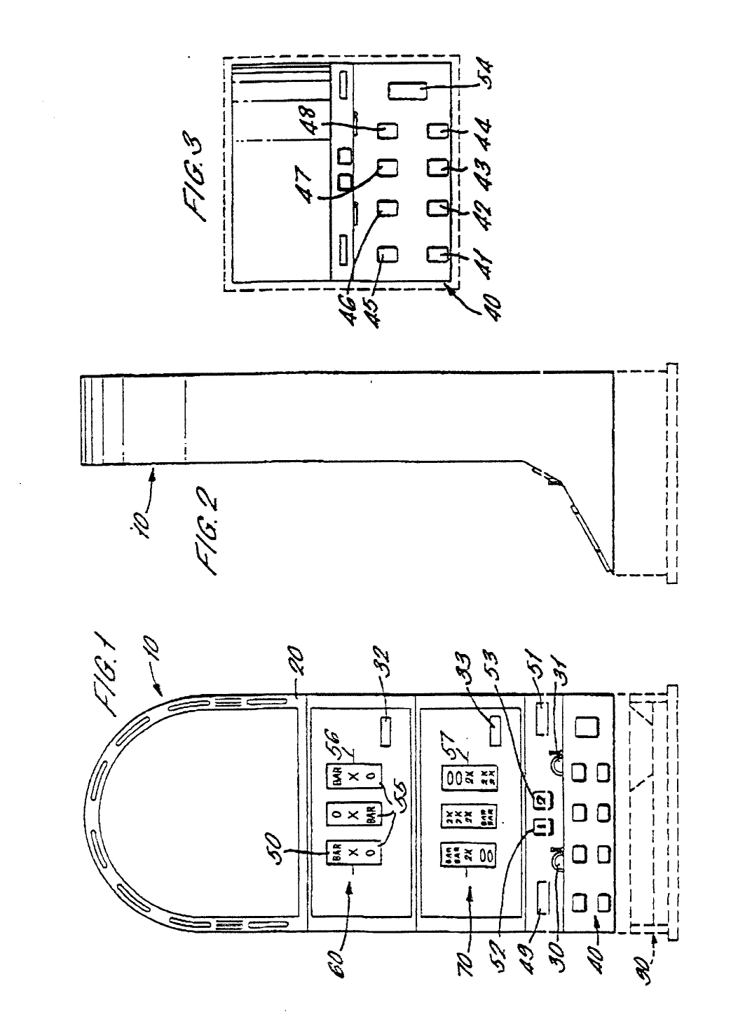

FIG. 1 is a front view of a first embodiment of gaming machine apparatus according to the present invention;

FIG. 2 is a side view of the gaming machine apparatus of FIG. 1;

FIG. 3 is a plan view of the gaming machine apparatus of FIGS. 1 and 2 showing a control panel of the gaming machine apparatus;

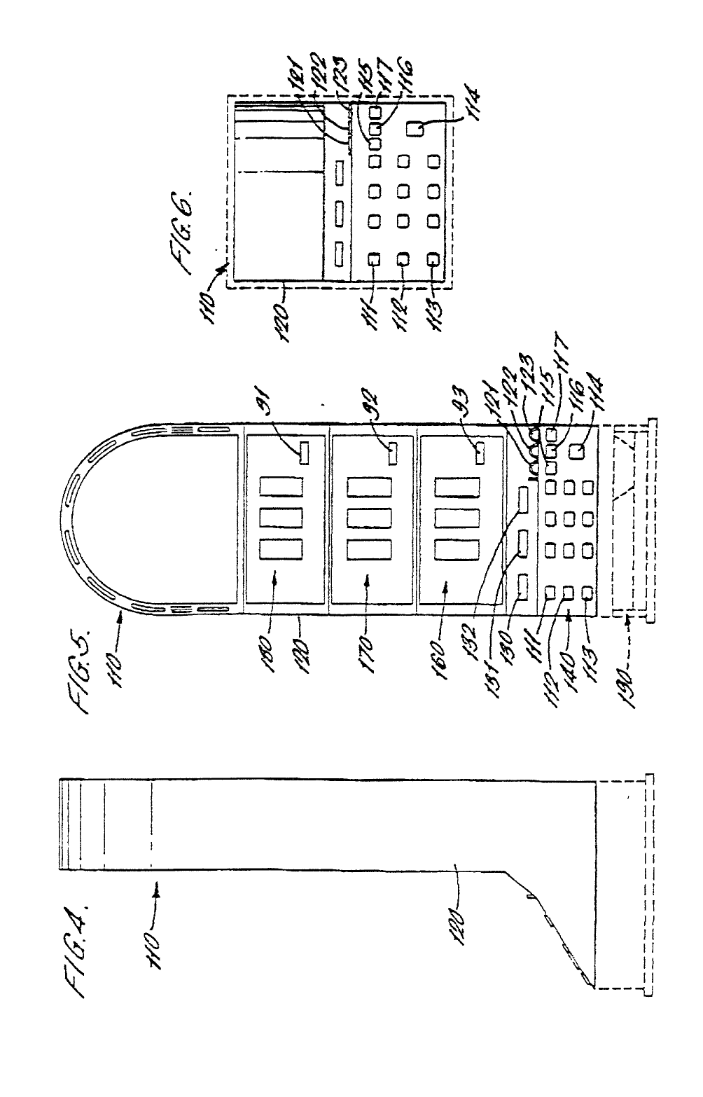

FIG. 4 is a side view of a second embodiment of gaming machine according to the present invention;

FIG. 5 is a front view of the second embodiment of gaming machine apparatus of FIG. 4;

FIG. 6 is a plan view of the gaming machine apparatus of FIGS. 4 and 5, showing a control panel of the gaming machine apparatus;

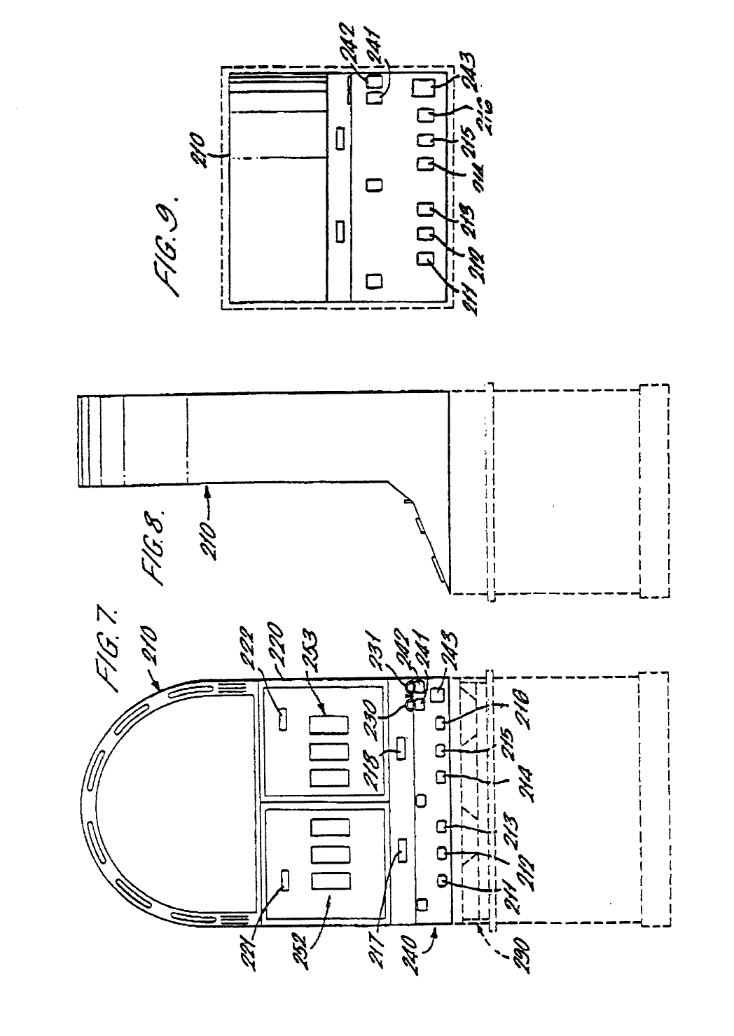

FIG. 7 is a front view of a third embodiment of gaming machine apparatus according to the present invention;

FIG. 8 is a side view of the gaming machine apparatus of FIG. 7;

FIG. 9 is a plan view of the gaming machine apparatus of FIGS. 7 and 8, showing a control panel of the gaming machine apparatus;

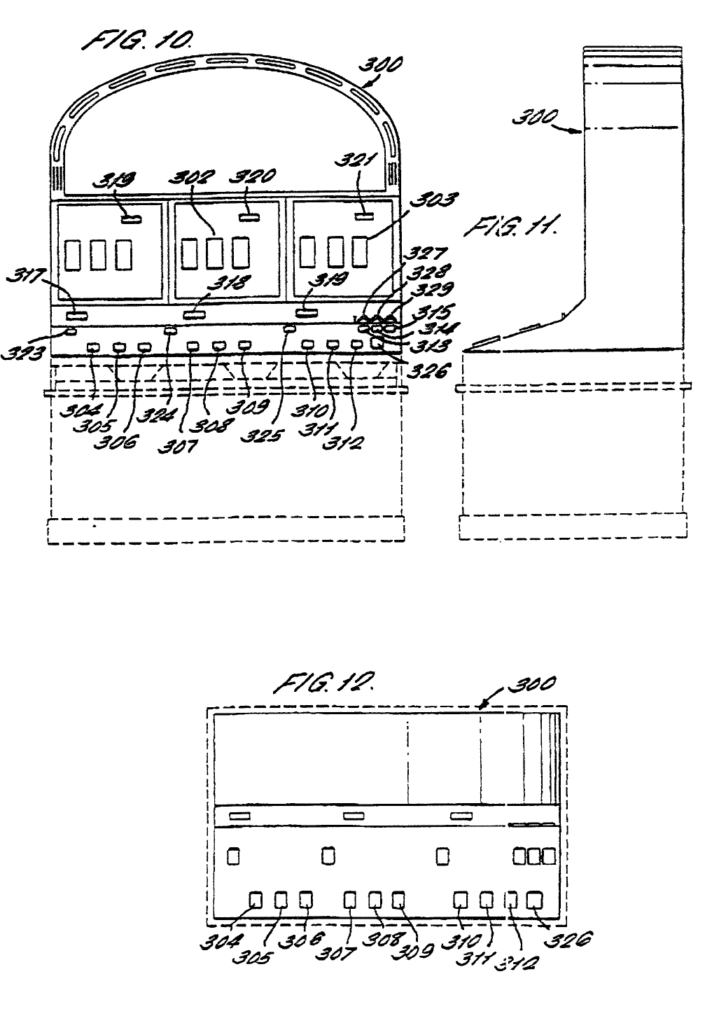

FIG. 10 is a front view of a fourth embodiment of gaming machine apparatus according to the present invention;

FIG. 11 is a side view of the further embodiment of gaming machine apparatus according to FIG. 10; and

FIG. 12 is a plan view of the fourth embodiment of gaming machine apparatus of FIGS. 10 and 11, showing a control panel of the fourth embodiment.

Referring now to FIGS. 1 to 3, a gaming machine apparatus 10 according to a first embodiment of the present invention is shown. A housing 20 of conventional construction such as, for example, wood or metal provides a secure structure within which the component parts of the gaming machine apparatus 10 are housed.

The gaming machine apparatus 10 has two randomisers, each having a set of reels 60, 70 associated herewith. Each randomiser is a conventional unit well known in the art. The randomisers are independent of each other and are used to generate a random combination of indicia 50 in each and every turn of play. Each set of reels 60, 70 comprises three reels 55 of given diameter having a common axis about which each can rotate. The circumferential edge of each reel 55 is provided with a plurality of indicia 50 selected from a set corresponding to the particular game format or theme. The indicia set may comprise, for example, representations of fruit.

Two coin receiving slots 30 and 31 and associated receiving apparatus of any conventional type known in the art is provided for receiving and registering that a player has deposited the necessary stake funds for at least one turn of play of a game.

A control panel 40, shown in detail in FIG. 3, comprises a plurality of buttons 41, 42, 43,44, 45, 46, 47, 48 and display panels 49, 51 for use by a player as an input/output devices in each turn of play of a game. The display panels 49, 51 have a number of displays indicating to a player the status of the gaming machine apparatus 10, for example, the level of credit remaining, the winnings banked and which of the randomisers is/are selected for play. The buttons 41 to 48 are selection means for each of the many functions possible and are used to operate the “start”, “cancel”, “hold” and “nudge” functions of a game. However, there are additional functions buttons 52, 53 provided which are used in the present invention to select and indicate a player's choice of randomiser to be played in each turn of play, the use of which is described in greater detail below.

A coin dispensing tray 90 and associated dispensing apparatus of any conventional type known in the art is provided for dispensing a player's winnings.

To play a game, a player must first deposit sufficient funds via one or both of the coin receiving slots 30, 31 to provide credit for at least one turn of play. Depositing of funds via the slot 30 provides credit in respect of the randomiser 60 and depositing of funds via the slot 31 provides credit in respect of the randomiser 70. The credit balance in respect of the randomiser with reels 60 is indicated to the player via the display panel 49. The credit balance in respect of the randomiser with reels 70 is indicated to the player via the display panel 51. Next, the player uses either one or both of the buttons 52, 53 to select either one or both of the respective independent randomisers to be played in that turn of play. This selection is confirmed via the display panels 49 and 51. The player then begins a turn of play by depressing the “start” button 54 on the control panel 40. An amount equal to that incurred by the player's selection, i.e. one unit charge where one of the available randomisers is selected for play and two unit charges in the case where both of the available randomisers are selected for play, is debited from the player's credit balance, and the remaining credit balance indicated on the displays 49 and 51. A player need not select both of the available randomisers for play in a turn of play. Either one or both of the randomisers may be selected for play in accordance with the player's wishes. For example, a player may wish to select just one randomiser to be played in a turn of play and may then select both randomisers for play in next turn of play, or vice-versa. Accordingly, the number of unit charges incurred in each turn of play is commensurate with the number of randomisers selected by that player for play in each turn of play. The credit balance for each randomiser is stored separately and reduced separately when a randomiser is selected in a turn of play. The running total of remaining credit is displayed by the screens 49, 51.

In every turn of play, both randomisers are simultaneously activated by the pressing of the “start” button 45 and the two sets of reels 60, 70 are spun about their common axes and subsequently come to rest so as to generate a random combination of indicia 50 which is determined by the position of the indicia 50 of the reels 55 relative to a fixed reference point, for example, the reference lines 56, 57 in FIG. 1. A player is a winner if the combination of indicia 50 generated by a randomiser and its associated set of reels 60, 70 selected for play in that turn of play matches a winning combination issued or published by the game organiser or promoter.

Both of the randomisers are activated in each and every turn of play, irrespective of whether both are selected for play by a player. If a player does not select a randomiser for play in a turn of play and the unselected randomiser is the only randomiser to generate a winning combination of indicia 50 in that turn of play, then the player is not a winner.

Winning combinations issued or published by the game organiser or promoter are programmed into the gaming machine apparatus 10 and in the case of a winning match, the corresponding cash prize is credited to the player and indicated accordingly by the respective “bank” display of display panels 32, 33. The display panel 32 is associated with the randomiser 60 and displays winnings gained by playing the randomiser 60. The display panel 33 is associated with the randomiser 70 and displays winnings gained by playing the randomiser 70. A player may cash his or her winnings for a randomiser 60, 70 at any time by depressing the respective “cancel” button 41, 45 on the control panel 40, whereupon the winnings are dispensed by the associated coin dispensing apparatus to the coin dispensing tray 95.

It is a feature of certain game formats or themes that in a turn of play one or both of the randomisers 60, 70 may invite a player to participate in that turn of play, in a way which influences the combination of indicia 50 generated by a or each of the randomisers. Typically, this participation involves the player by inviting activation of one or more of the function buttons 42, 43, 44, 46, 47, 48. The buttons 42, 43, 44 are associated one each with one of the reels of randomiser 70. The buttons 46, 47, 48 are associated one each with one of the reels of randomiser 60. The button 42 permits, for example, a reel 55 to be “held”, i.e. refrained from rotating in a turn of play, or be to “nudged” i.e. rotated in either direction relative to the other reels in the same set, functions which are well known in the art of gaming machines. The buttons providing the “nudge” or “hold”features are randomly enabled and are only enabled for a selected randomiser, pre-selected by the player using the buttons 52, 53.

A second embodiment of a gaming machine apparatus 110 according to the present invention is shown in FIGS. 4, 5 and 6. This second embodiment is similar to the first in that it comprises a housing 120, coin receiving slots 130, 131, 132 and associated coin receiving apparatus, a control panel 140, a coin dispensing tray 190 and associated coin dispensing apparatus. However, in this second embodiment there are three independent randomisers with three different sets of reels 160, 170, 180 provided for play. Additional buttons and displays are provided on the control panel 140 to control and indicate the status of the third randomiser and its associated set of reels 180. The operation of the second embodiment of gaming machine apparatus 110 is identical to that of the first embodiment described above, save there are three independent randomisers for a player to select in each turn of play. A player play the game in a similar fashion to that described above. To play a game, a player must first deposit sufficient funds via one or more of the coin receiving slots 121, 122, 123 to provide credit for at least one turn of play. The credit balance for each randomiser is indicated to the player via a respective display panel 91, 92, 93. Next, the player uses buttons 115, 116, 117 provided on the control panel 140 to select either one, two or all three of the respective independent randomisers for play in that turn of play. This selection is confirmed via the display panels 130, 131, 132. The player begins a turn of play by depressing the “start”button 114 on the control 140. An amount equal to that incurred by the player's selection, i.e. one unit charge where one of the available randomisers is selected for play, two unit charges in the case where two of the available randomisers are selected for play, is debited from the player credit balance, and the remaining credit balances indicated on the display 130, 131. 132. The credit balances for each randomiser are maintained separately and displayed separately. A player need not select all three of the available randomisers for play in a turn of play. Any one, two or all three of the randomisers may be selected for play in accordance with the player's wishes. For example, a player may wish to select two randomisers to be played in a first turn of play and may then select, for instance, just one randomiser for play in a next turn of play. Accordingly, the number of unit charges incurred in each turn of play is commensurate with the number of randomisers selected by the player in each turn of play. All three randomisers are simultaneously activated by the depression of the single start button 114 and all three associated sets of reels 160, 170, 180 spin in every turn.

A third embodiment of a gaming machine apparatus 210 according to the present invention is shown in FIG. 7, 8 and 9. This third embodiment is similar to the first embodiment in that it comprises a housing 220, coin receiving slots 230, 231 and associated coin receiving apparatus, a control panel 240, a coin dispensing tray 290 and associated coin dispensing apparatus. However, in this third embodiment the reels of the two independent randomisers are set out side by side in sets 252, 253. Buttons and displays associated with each of the independent randomisers are provided on the control panel 240 laid out side by side. Three buttons, 211, 212, 213 which enable “nudge” and “hold” functions for the reels of set 252 are provided therebelow. Three buttons, 214, 215, 216 which enable “nudge” and “hold” functions for the reels of set 253 are provided therebelow. A screen 217 indicating the credit registered in respect of the randomiser with reel set 252 is provided below reel set 252 and a screen 218 indicating the credit registered in respect of the randomiser with reel set 253 is provided below reel set 253. A screen 221 indicates winnings for the randomiser with reel set 252 and a screen 222 indicates winnings for the randomiser with reel set 253. The operation of the third embodiment of gaming machine apparatus 210 is identical to that of the first embodiment described above. A player plays the game in a similar fashion to that described above. To play a game, a player must first deposit sufficient funds via one or both of the coin receiving slots 230, 231 to provide credit for at least one turn of play. The credit balances are indicated to the player via the display panels 21, 218 on the control panel 240. The player uses the buttons 241, 242 provided on the control panel to select either one or both of the respective independent randomisers to be played in that turn of play. This selection is confirmed via the display panels 217, 218. The player begins a turn of play by depressing the “start” button 243 on the control panel 240. An amount equal to that incurred by the player's selection, i.e. one unit charge where one of the available randomisers is selected for play and two unit charges in the case where two of the available randomisers are selected for play, is debited from the appropriate player's credit balances, and the remaining credit balances indicated by the display panel 217, 218. A player need not select both of the available randomisers for play in a turn of play. Either one or both of the randomisers may be selected for play in each turn of play in accordance with the player's wishes. When a randomiser has been selected then the buttons providing “nudge” or “hold”functions associated therewith are randomly enabled to add extra features to the game play. At least three indicia of each reel will be visible to a player when the reel is stationary.

A fourth embodiment 300 of gaming apparatus is shown in FIGS. 10, 11 and 12. It is very similar to the second embodiment 110 of apparatus in that it comprises three randomisers with three associated sets of reels 301, 302, 303 each of which generates indicia randomly and completely independently. The apparatus has three sets of “nudge”/“hold” buttons (304, 305, 306; 307, 30, 309; 310, 311, 312), one for each randomiser. Three selection buttons 313, 314, 315 are provided to allow selection between the three randomisers. Three coin slots 327, 328, 329 allow deposit of stake money for each of the randomisers. Three screens 316, 317, 318 show the credit stored in respect of each of the randomisers (the credit totals are kept separately). Three screens 319, 320, 321 show the winnings attributed to each randomiser. Three cancel buttons 322, 323, 324 allow cancellation of a “hold” or “nudge” feature and also allow dispensing of winnings, each button working independently for a particular set of reels. A single start button 326 is provided and in every turn of play all the reels of every set spin and thereby randomly generate indicia. To play the apparatus, a player must deposit stake money via one or more of the slots 327, 328, 329 and then must select one or more randomisers for play using the buttons 313, 314, 315. Randomly the apparatus will offer “hold” functions for a selected set of reels. The start button 326 is depressed and all reels of all three sets spin and stop. A “nudge” function is randomly offered in respect of a selected set of reels. A win is recorded if a winning combination of indicia is displayed by a single set of reels and if the reels have previously been selected. The selector buttons will only allow selection of a set of reels if sufficient credit is stored in respect of the set. No win is awarded for a winning combination of indicia generated by a set of reels not selected.

It will be appreciated that changes to the number and/or functions of the buttons and displays provided on the control panel corresponding to each of the independent randomisers may be made to the gaming machine apparatus of the present invention to cater for the numerous different game formats and themes possible. For example, where there is provided a set of buttons for each independent randomiser, the control panel may become large and cumbersome where there are a large plurality of randomisers. Accordingly, it may be preferable to have only one set of buttons which can be selected for use with each independent randomiser by use of the selector buttons.

It will be appreciated from the above description that any number of independent randomisers may be provided with a gaming machine apparatus according to the present invention.

In each embodiment of the present invention the player of the gaming machine apparatus in each turn of play chooses which set of reels he wishes to select for the purposes of gambling his stake. The player can choose to play only one of the sets of reels, two sets out of three (in the case of the three sets of reels embodiment) or all sets of reels. However, in each turn of play, all of the sets of reels will spin and any of the sets of reels could indicate a win. A player may find that he or she has not selected a set of reels which shows a win or could find that he or she has won twice in a single turn of play by selecting two randomisers which both generate winning combinations of indicia.

Whilst in the preferred embodiments described above the means for accepting payment comprises a coin receiving slot and associated receiving apparatus, it will be appreciated that any means of accepting credit well known in the art may be employed in a gaming machine apparatus according to the present invention. For example, a payment accepting means may be provided to accept tokens, notes, credit cards or charge cards. Alternatively, the gaming machine apparatus may be linked to a central electronic memory holding account details of a player and a player may identify him or herself to the gaming machine apparatus by, for example, entering a personal identification number, and in each turn of play the gaming machine apparatus adjusts the personal account of the player stored in the electronic memory.

In every embodiment above in every turn of play the indicia generated by each set of reels are generated independently by a randomiser associated only with one set of reels. Thus the random generation of symbols by one set of reels has no effect whatsoever on the random generation of symbols by a second set of reels. Furthermore, no wins are awarded by combining indicia generated by one set of reels with indicia generated by a second set of reels; each set of reels is considered independently of the other or others in determining a win.

1. Apparatus for playing a game comprising:
a payment acceptor for receiving payment of a stake from a player of the game;
a plurality of randomisers each of which can generate a random combination of indicia from a set of available indicia;
a plurality of selectors operable by a player for selecting one or more of the plurality of randomisers to be played in a turn of play;
activating means for activating the randomisers;
comparator means for determining a winning combination of indicia; and
payment means for awarding a winning payment to a winning player of the game; wherein:
the activating means in every turn of play activates all of the randomisers and in every turn of play each randomiser generates a random combination of indicia;
each of the randomisers comprises a set of rotatable mechanical reels;
the randomisers operate independently of each other such that the chances of one randomiser generating a particular set of indicia are completely unaffected by the indicia generated by any other randomiser;
each of the plurality of selectors is associated with only one of the plurality of randomisers and is used by a player to select only the associated randomiser for play in a turn of play; and
the comparator means determines a winning combination of indicia by both,
separately for each set of reels checking whether the generated indicia comprises a winning combination; and
by checking which set or sets of reels have been selected for play;
the comparator means determining a win only when a selected set of reels displays a winning combination of indicia.

2. Apparatus for playing a game as claimed in claim 1 wherein the reels of each set of reels rotate around a common axis, the reels having indicia provided thereon and being arranged so that in each turn of play upon operation of the activation means, the reels are spun and subsequently come to rest so as to generate a random combination of indicia which is determined by the position of each indicia relative to a fixed reference point.

3. Apparatus for playing a game as claimed in claim 2 wherein a sequence of indicia is provided around the circumferential surface of each reel and at least three vertically spaced indicia of each reel are visible to the player of the game when the reel is stationary.

4. Apparatus for playing a game as claimed in claim 2 or claim 3 wherein each set of reels has a manually operable first control means associated therewith operable to rotate one or more chosen reels of the respective set of reels relation to the other reels of the same set of reels.

5. Apparatus as claimed in claim 4 wherein each first control means offers to the player an opportunity of rotating one or more reels in a set relative to the other reels of the set on a random basis and only when the first control means has determined that the respective set of reels was selected for play by the player using one of the selectors.

6. Apparatus for playing a game as claimed in claim 4 or claim 5 wherein each set of reels has associated therewith manually operable second control means associated therewith operable to hold stationary one or more chosen reels of the respective set of reels in a turn of play.

7. Apparatus for playing a game as claimed in claim 6 wherein each second control means offers to the player an opportunity of holding stationary one or more reels in a set on a random basis and only when the second control means has determined that the respective set of reels was selected for play by the player using one of the selectors.

8. Apparatus for playing a game as claimed in any one of the preceding claims comprising a plurality of payment acceptors each of which is associated with only one of the plurality of randomisers and selection of a randomiser by the player requires both payment of a stake by the player using the payment acceptor associated with the chosen randomiser and also operation of a selector to select the chosen randomiser.

9. Apparatus as claimed in claim 8 wherein each payment acceptor can accept and record payment of a stake sufficient to enable the randomiser associated therewith to be selected in a plurality of turns of play.

10. Apparatus as claimed in any one of the preceding claims wherein the activating means operable by the player to activate simultaneously all of the randomisers comprises a single button.

11. Apparatus for playing a game as claimed in any one of the preceding claims wherein each payment acceptor comprises a coin/token receiving mechanism.

12. Apparatus for playing a game as claimed in any one of the preceding claims wherein each payment acceptor comprises a note receiving mechanism.

13. Apparatus for playing a game as claimed in any one of the preceding claims wherein each payment acceptor comprises a bank card reading mechanism.

14. Apparatus for playing a game as claimed in any one of the preceding claims wherein each payment acceptor comprises means for identifying the player of the game and in each turn of play adjusts a personal account of the player stored in an electronic memory.

15. Apparatus for playing a game as claimed in any one of the preceding claims wherein the selectors operate independently of each other and there is no requirement on a player to select any one randomiser before the player can select another randomiser.

16. Apparatus for playing a game as claimed in any one of the preceding claims where the payment means comprises a coin dispensing mechanism.

17. Apparatus for playing a game in any one of the preceding claims where the payment means comprises a plurality of electronic memory means, each electronic memory means being associated with a different one of the randomisers and each memory means storing from a respective memory means the winnings of the player accumulated by playing the said randomiser means.

18. Apparatus for playing a game as claimed in claim 9 wherein each payment acceptor has associated visual display means which displays to the player payment accepted by the acceptor not yet used to facilitate the selection of a randomiser in a turn of play.
